(19) United States
(12) Patent Application Publication
(10) Pub. No.: US 2006/0165009 A1
(43) Pub. Date: Jul. 27, 2006

(54) Systems and methods for traffic management between autonomous systems in the Internet

(75) Inventors: Luc T. Nguyen, Atlanta, GA (US); Garry T. Williams, Roswell, GA (US); Laurent Oget, Atlanta, GA (US); David M. Goodman, Atlanta, GA (US); Abhijeet Shah, Atlanta, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Zvolve

(21) Appl. No.: 11/042,539

(22) Filed: Jan. 25, 2005

(51) Int. Cl. H04L 12/28; H04L 12/56

(52) U.S. Cl. 370/252; 370/254; 709/223; 370/229

(57) ABSTRACT

Systems and methods are disclosed for managing the traffic between autonomous systems in the Internet. Data on links on border routers between autonomous systems is collected and analyzed at certain traffic times. Once determined, traffic on various customer facing interfaces at that time is associated with an Internet Prefix. Then, the aggregate traffic volume for each Internet Prefix is allocated to a first link on a primary routing basis and to a second link on a secondary routing basis. These routes are announced to a provisioning system that in turn, configures various border routers, which in turn announce the new routes using the Internet Border Gateway Protocol. In this manner, inter-autonomous traffic is managed to facilitate traffic distribution on the links according to criteria defined by network provider, allowing resources to be better utilized and network traffic to be maintained if a link fails.

### FIELD OF THE INVENTION

The present invention relates generally to managing data traffic between computer networks, and specifically relates to real-time management of Internet traffic between autonomous systems involving the use of the Border Gateway Protocol (BGP).

### BACKGROUND OF THE INVENTION

The Internet has been defined as a collection of disparate computer networks that can function as a coordinated network. It is precisely this attribute that has been credited for the rapid growth rate of the Internet and why it has become the backbone for many popular services and capabilities, such as the World Wide Web, electronic email and messaging, and electronic commerce. Because the Internet was designed to adapt to changing conditions, it allows other parts of the network to function if one of the elements in the network failed. Further, the Internet is designed to easily allow new computer systems/networks to connect to the Internet, and mechanisms are defined to readily allow routing information of new computer systems/networks propagate throughout the network.

A network connected to the Internet can be modeled as a set of nodes corresponding to routers interconnected by communication links. A path can be viewed as a set of one or more one-way communication links connecting the nodes, allowing the two nodes to communicate with each other. A set of nodes under a common technical administration (e.g., corporate enterprise, common carrier, private network, Internet Service Provider) can considered an Autonomous System (“AS”) and can use one of the various forms of protocols to communicate with each other. These Interior Gateway Protocols route messages (packets) from one node (router) to another. In many instances, the procedures for managing traffic within an autonomous system can be proprietary or non-standard. Such mechanisms are explained in the product literature and other resources available from many equipment manufacturers. Network operators have an interest in managing traffic between nodes in their own networks in an efficient manner, so as to minimize capital costs and increase customer satisfaction. One such approach is disclosed in U.S. patent application Ser. No. 09/970,448, publication number 2003/0,046,426, entitled “Real Time Traffic Engineering Of Data-Networks”, filed on Oct. 2, 2002, the contents of which are incorporated by reference. Further, the method of defining priorities to individual traffic based on user defined criteria is disclosed in U.S. patent application Ser. No. 09/970,396, publication no. 2002/0,123,901, entitled “Behavioral Compiler For Prioritizing Network Traffic Based On Business Attributes”, filed on Oct. 2, 2001, the contents of which are also incorporated by reference.

However, when one autonomous system needs to communicate with another autonomous system, then there must be agreement as to what protocol must be used and how traffic will be routed. That protocol is agreed to by the industry to be the Border Gateway Protocol (“BGP”). Further information regarding the BGP can be found in documents defining the Internet's operation, including IETF RFC 1772.

Examples of various types of autonomous systems are shown in FIG. 1. Turning to FIG. 1, an autonomous system could be a corporate enterprise LAN 110, 170. Another form of an autonomous system could be an Internet Service Provider (ISP), such as illustrated by AS-2 120, AS-3 130 AS-5 150, and AS-6 160. There are many well known providers in existence ranging from small regional to large national providers, such as Earthlink™ or AOL™. These providers are well known for handling small as well as large customers. Some providers may focus from a business perspective on larger customers or providing interconnection between ISPs. These represent “backbone” or network providers, and examples include UUnet™ and Level 3™, although they may also handle smaller, individual users. Those skilled in the art of the Internet will realize that many variations are possible.

When users (or more accurately, an end system or computer) on the Internet desire to communicate to other users, they do so by using Internet Protocol (IP) addresses. Each end system has a 32 bit IP address, and each message sent has an originating address and a destination address. Turning to FIG. 1a, when PC-1 101a sends information to PC-2 101b, the originating address is that of PC-1 101a and the destination address is that of PC-2 101b. This path is represented by dashed line 116. If PC-2 sends a response message, then the message would originate from PC-2 with the originating address being the IP address of PC-2 and the destination address would be that of the IP address of PC-1. Further, since both of these users obtain service from the same autonomous system or ISP 120, the traffic is contained within AS-2 (specifically, it is intra-network to AS-2). There is no need for the traffic to traverse other autonomous systems, such as AS-3 130 or AS-4 140. Because the ISP can control the traffic from ingress to egress, the ISP can control the path taken by the messages. This allows the ISP to monitor the amount of intra-network and establish paths to optimize the available network resources. Although Figure la does not show the internal network infrastructure, it can be assumed that AS-2 120 comprises various routers and it is possible that the links are interconnected.

FIG. 1a also discloses traffic that originates in PC-1 101a and terminates in an Enterprise LAN, AS-7 170. An Enterprise LAN can be a private network associated with a corporate enterprise, and many of these can be very large. For example, an Enterprise LAN for a large international corporation may be as large as or larger than an ISP. Thus, even an Enterprise LAN can be an autonomous system. Further, an Enterprise LAN could be very small, having only a few IP addresses. In FIG. 1a, traffic originating from Enterprise LAN AS-1 110 would have a computer originating the traffic (not shown) with an IP address used as the originating address that is sending traffic (represented by dashed line 126) to a destination computer (not shown) identified by a destination IP address within the AS-7 Enterprise LAN 170. In this embodiment, AS-2 act as a transit autonomous system accepting traffic, examining the destination address, and selecting the proper outgoing link 231. Similarly, AS-4 receives messages on an incoming link 231, and as defined by the routing tables established within AS-4, routes the message to an outgoing link 153. For the moment, we can assume that information sent in the other direction takes the same path 126.

Although various autonomous systems may be involved in conveying traffic between the originating and destination system, as shown in FIG. 1a, certain issues can be explained and illustrated using only two autonomous systems. Thus, for the present purpose of illustrating one of the problems relating to managing traffic, a portion of the network is examined further.

Recall that in FIG. 1a that when PC-1 and PC-2 exchanged data (regardless of direction), that the traffic was contained with AS-2 and it is presumed that AS-2 was able to manage the data. Specifically, AS-2 can define the path the data would take, and perhaps its priority relative to other traffic, etc. Because all the resources used to route the traffic are within the administration of AS-2 (e.g., by definition an autonomous system is a collection of routers under a common administrative control), AS-2 can effectively manage the traffic from originating system to destination system.

However, in the case of traffic 126 between AS-1 101a and the Enterprise LAN AS-7 170, AS-2 has only partial control of the resources required to convey the traffic between the origination and destination. Assume traffic is originating from PC-1 to AS-7. That means that AS-2 receives the traffic when it originates from AS-1, routes it internally in some manner, and selects which outgoing link 231, 232, or 233 is used to pass the to AS-4.

This is illustrated in detail in FIG. 2. In FIG. 2, AS-2 is shown as having three routers, R1 211, R2, 212, and R3 213. R1 has one link 231 to AS-4. R2 has two links 232, 233 to AS-4. Finally, R3 has one link 234 which goes to AS-3. Although the most direct route to the end system is via AS-4, it is possible that AS-2 could route the traffic to AS-3, which in turn could pass it to AS-4 over one of the links 261, 262, 263 that terminate on AS-4.

It is evident in this case that that link used by AS-2 to convey traffic from AS-2 to AS-4 is under the control of AS-2. Further, because these links are very expensive, limited in number, it is desirable that the traffic effectively and efficiently use the capacity of the links. Thus, AS-2 can define certain policies for using certain links to convey traffic. Obviously, it would not be desirable for AS-2 to exclusively use one link (such as link 231) and not use any others links (such as 232, 233) since that if there is congestion (e.g., a temporary large volume of traffic on the selected link), a queue may form in R1. Thus, traffic may be lost and other links may be under utilized. This could be avoided by evenly distributing the traffic on the other links. Thus, it is desirable to distribute the load across available resources so that delays are avoided by overburdening one of the resources. It is in the interest of the various providers to efficiently use the resources and minimize any traffic delay between autonomous systems. At least AS-2 can select which router and link is used for outgoing traffic. It is not obvious how AS-2 can control incoming traffic from AS-4.

Frequently, multiple links are used to provide backup capabilities in case of failure of one of the links. This presents some unique challenges with respect to managing traffic, as illustrated in FIG. 3a-3d. Turning to FIG. 3a, three links 233, 232, 231 are shown between AS-2 120 and AS-4 140, with each assumed to have the same capacity. In this embodiment, each link is loaded at 60% of total link capacity. In FIG. 3b, a failure 300 is shown associated with link 2. The failure could be a cut in the transmission facility, failure of the electronics associated with it (e.g., the router), or even a planned outage for maintenance purposes. In the Internet, procedures are defined for allocating a routing priority scheme. Essentially, traffic is directed to a first link if that link is available and to a second link as an alternate. If the first link goes down, then the second link is selected, and so on. Because this routing information is established before a failure occurs, reaction to a failure can occur quickly. Because of the reliability of equipment and the complicated planning associated with accommodating multiple simultaneous failures, ISPs typically plan on handling only a single link failure. Thus, typically, a route is only associated in an ISP with a primary and secondary route.

In FIG. 3c, it becomes apparent how using a secondary routing scheme along with multiple links can increase reliability during a link outage. Assuming for the moment that the traffic is traveling from AS-4 to AS-2, the apparent solution is to place half of the traffic 304 that was to go over link 2 232 into link 1 231, and the other half of the traffic 302 from link 2 232 onto link 3 233. Since link 2 was operating at 60% capacity, half of that traffic would be 30% capacity. Adding 30% capacity to link 1 and 30% capacity to link 2, results in the two remaining links operating at 90% capacity as shown in FIG. 3d. The two remaining links 233, 231 are able to absorb the capacity and traffic interruption is minimized.

The above example has glossed over several problems that are not readily solved in the current Internet architecture. For example, in FIG. 3a, it is assumed that each of the three links is evenly loaded. Achieving this is in itself, not trivial. Even if an ISP operator can manually allocate traffic evenly, any growth in subscribers or traffic from existing subscribers is likely to impact the allocation of the traffic over time. Thus, over time, link 1 may grow so that it is operating at 75% of capacity. While this, in and of itself is not a problem, it becomes a problem in FIG. 3c when a link fails and the traffic is reallocated. In the embodiment of FIG. 3, adding 30% capacity to a link operating at 75% capacity means the link must now carry 105% of capacity. Thus, traffic will be lost or queued. Further, if link 1 and 3 remain at 60% of capacity, but link 2 grows to 84% of capacity, then 42% capacity must be allocated to both link 1 and 2, resulting in each attempting to carry 102% of capacity. If all links increase, the problem is aggregated and it is not clear necessarily when the problem has first manifested itself. Obviously, a network operator does not prefer to discover the problem when a link failure has occurred resulting in lost traffic. Further, the links were assumed to have the same capacity, whereas in most applications, links of differing capacity are deployed.

Further complicating the scenario is that traffic at a router is routed based on an IP address. Routers cannot simply redirect 50% of their traffic to another link, nor would that make sense. For example, redirecting every other packet of a video stream would result in 50% of the traffic being redirected, but the problems on the receiving system are immense. Rather, traffic is redirected based on IP address. However, each instance of communication between end systems may vary significantly and are not necessarily uniform. For example, one video conference may consume the same bandwidth as hundreds of users surfing the world wide web or thousands of users checking email. Further, the traffic levels change constantly throughout the day. Thus, traffic levels during one hour may be significantly different than traffic levels during the following hour.

To complicate matters even further, it becomes apparent from FIG. 2 that there is more than one path that can be used to convey traffic from AS-2 to AS-4. Although the preceding discussion focused on use of the links 231, 232, 233 to carry traffic from AS-2 to AS-4, it is also possible to relay the traffic via AS-3. Thus, AS-4 could send traffic to AS-3 over one or more of the links 261, 262, 263 and then AS-3 would relay it over link 234 to AS-2. Given that there is only one link between AS-3 and AS-2, similar concerns exist regarding overloading that link as well during a failure condition.

It becomes apparent that the problem can be very complex and explains why many ISP operators have been heretofore unable to manage traffic between autonomous systems in an effective manner. Typically, reliance is made on manual engineering, and periodic re-engineering actions are difficult and error prone. Further, it is possible that reallocation of traffic manually may actually worsen the situation, if not performed correctly. For example, since networks are typically engineered at times of peak traffic, measuring the network's operation at an off-peak time and engineering around those values is an incorrect methodology. It is quite likely that when the peak traffic occurs, then adverse consequences will be discovered.

One solution is simply to add more links between the autonomous systems. However, as previously mentioned the links are extremely expensive, and because they must be coordinated between the two autonomous systems, it is not a simple matter for one Internet Service Provider to simply unilaterally decide to deploy additional links to another ISP.

Thus, it is apparent that systems and methods are required for network operators to better manage their traffic on inter-network links (a.k.a. gateway links). This need includes an approach for directing how traffic is handled, evenly distributing traffic during normal operation on the set of available resources (e.g., the gateway links), and ensuring that during a failure situation, traffic is redistributed in the most efficient manner for the resources that are available.

### BRIEF SUMMARY OF THE INVENTION

In one embodiment of the invention, a method of managing traffic on a plurality of links is claimed between a first autonomous system and a second autonomous comprising the steps of receiving a plurality of traffic measurement data associated with a plurality of customer facing interfaces associated with the first autonomous system wherein the traffic measurement data is associated with the traffic time, allocating each one of the plurality of the traffic measurement data to one of a plurality of Internet prefixes, wherein each Internet prefix is associated with the first autonomous network, determining an aggregate traffic volume associated with each of the one of the plurality of Internet prefixes by summing each one of the traffic measurement data associated with the one of the plurality of Internet prefixes, primarily mapping each Internet prefix to one of the plurality of links, secondarily mapping each Internet prefix to another one of the plurality of links, storing a table comprising the primarily mapping and secondarily mapping of each Internet prefix in a memory of a traffic management system, and communicating the primarily mapping and secondarily mapping of each Internet prefix to a provisioning system using an interface of a traffic management system. In another embodiment of the present invention, a computer readable media containing software for managing traffic between a first ISP and a second ISP, the software instructing a processor to perform the steps of retrieving a plurality of customer facing interfaces (CFIs) traffic measurements from a memory wherein each of the CFI traffic measurements are associated with a time, retrieving a plurality of Internet prefixes from the memory, allocating each one of the plurality of CFI traffic measurements to one of a plurality of Internet prefixes thereby associating each one of the plurality of CFI traffic measurements to one of the Internet prefixes, determining an aggregate Internet prefix traffic volume for each Internet prefix by summing each one of the plurality of CFI traffic measurements allocated to the one of the plurality of Internet prefixes and repeating for each Internet prefix, mapping each one of the plurality of Internet prefixes on a primary basis to a first identifier associated with a first link conveying traffic from the second ISP to the first ISP, mapping each one of the plurality of Internet prefixes on a secondary basis to a second identifier associated with a second link conveying traffic from the second ISP to the first ISP, summing a plurality of aggregate Internet prefix traffic volumes mapped to the first link on a primary basis producing a first link primary allocated traffic volume, verifying that first link primary allocated traffic volume does not exceed a target traffic volume associated with the first link, summing a plurality of the aggregate Internet prefix traffic volumes mapped to the first link on a secondary basis producing a first link secondary allocated traffic volume , verifying that the sum of the first link primary allocated traffic volume and the first link secondary allocated traffic volume does not exceed a traffic capacity associated with the first link, storing the mapping of each one of the plurality of Internet prefixes on a primary basis to the first identifier and the mapping of each one of the plurality of Internet prefixes on a secondary basis to the first identifier in a memory as configuration data in a memory, and generating a series of messages on an interface of a computer system indicating a plurality of BGP protocol attributes based on the configuration data.

In yet another embodiment of the invention, a system is disclosed for managing Internet traffic received by a first ISP from a second ISP over a plurality of links comprising a data collection store maintaining in a memory, wherein the data store includes:
a) a plurality of Internet prefix data associated with the first ISP,
b) a plurality of customer facing interface (CFI) traffic volume data associated with a traffic time,
c) a plurality of link identifiers associated with the plurality of links,
d) a plurality of link traffic capacity data, wherein each one of the plurality of link traffic capacity data is associated with one of the plurality of link identifiers,
e) a plurality of aggregate Internet prefix traffic volume data wherein each one of the plurality of aggregate Internet prefix traffic volume data represents the aggregate traffic associated with one of the Internet prefix data,
   wherein the system further comprises a processor operatively connected to the database for retrieving and storing data and the processor is configured to:
a) retrieve the plurality of CFI traffic volume data and associate each one of the plurality of CFI traffic volume data with one of the plurality of Internet prefix data and summing each of the CFI traffic volume data associated with a given one of the plurality of Internet prefix data thereby producing the aggregate Internet prefix traffic volume data,
b) associate each one of the plurality of Internet prefix data with one of the plurality of link identifiers on a primary basis,
c) associate each one of the plurality of Internet prefix data with another one of the plurality of link identifiers on a secondary basis,
d) sum each of the aggregate Internet prefix traffic volume data associated on a primary basis for the one of the plurality of link identifiers thereby producing a primary aggregate link traffic volume data,
e) verify that the primary aggregate link traffic volume data does not exceed a target fill level associated with the one of the plurality of link identifiers,
f) store the association of each one of the Internet prefix on a primary basis and each one of the Internet prefixes on a secondary basis in the data collection store;
   and the system still further comprising a provisioning system, operatively communicating with the processor, configured to receive a plurality of route announcements.

Other embodiments of the invention are disclosed herein and the above is not intended to be a complete summary of all aspects of the invention, nor is the summary intended to limit or interpret the claims.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 represents one embodiment of a prior-art inter-autonomous system architecture;

FIG. 1a represents one embodiment of traffic routed in a prior-art inter-autonomous system architecture;

FIG. 2 represents one embodiment of a prior-art inter-autonomous system architecture;

FIGS. 3a-3d represent one embodiment of failures and handling thereof in an inter-autonomous system communication;

FIG. 4 illustrates one embodiment of the prior art application of the BGP protocol;

FIG. 5 illustrates one embodiment of an Internet Prefix;

FIG. 6 illustrates one embodiment of the major components according to the principles of the present invention;

FIG. 7 illustrates one embodiment of a measured bandwidth table according to the principles of the present invention;

FIG. 8 illustrates one embodiment of measuring the customer facing interfaces according to the principles of the present invention;

FIG. 9a illustrates one embodiment of mapping IP addresses to Internet Prefixes according to the principles of the present invention;

FIG. 9b illustrates one embodiment of a Internet Prefix bandwidth table according to the principles of the present invention;

FIG. 10a illustrate one embodiment of allocating Internet Prefixes to links according to the principles of the present invention;

FIG. 10b illustrates another embodiment of allocating Internet Prefixes to links according to the principles of the present invention;

FIG. 10c illustrates a representation of allocation of Internet Prefixes during a link failure;

FIG. 10d illustrates another representation of allocation of Internet Prefixes;

FIG. 10e illustrates still another representation of allocation of Internet Prefixes during a link failure;

FIG. 11 illustrates one embodiment of the provisioning aspects according to the principles of the present invention;

FIG. 12 illustrates one embodiment of the attribute tables according to the principles of the present invention; and

FIG. 13 represents one embodiment of the process for managing traffic according to the principles of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

One embodiment of the current invention relies on the use of an existing Internet protocol called the Border Gateway Protocol (BGP). BGP allows communication of “reachability” or routing information between two entities and presumes that the two entities operate on the information in a certain manner. The BGP information is used to exchange network information from one network (or autonomous system) to another. Typically, the routers at the border (called border routers) of an autonomous system function as BGP speakers, and exchange information as peers. The information exchanged includes a list of IP addresses or network prefixes that terminate in a given autonomous system. Thus, a first autonomous system will inform a second autonomous system of all the addresses served by the first autonomous system.

The BGP protocol allows other information to be exchanged, including preference information as to how the routes are used between the autonomous systems. These are called “attributes” and BGP defines a hierarchical process of how each attribute is examined to determine how to route data. One of these attributes is called the “Multi-Exit Discriminator” (MED). While it is not necessary to review all the functions of the various attributes, it is useful to explain how the MED functions as that is one component of BGP that can in an embodiment of the present invention.

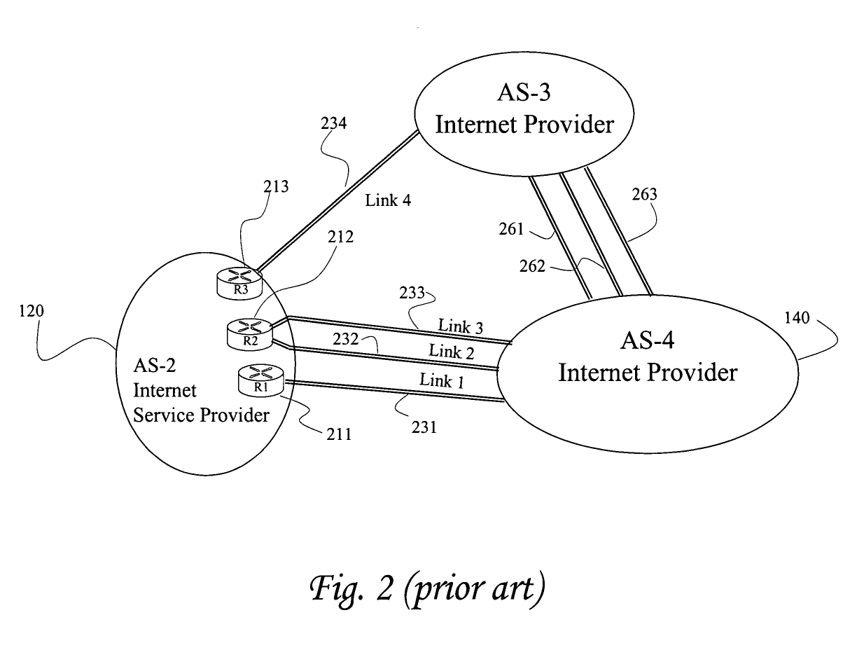

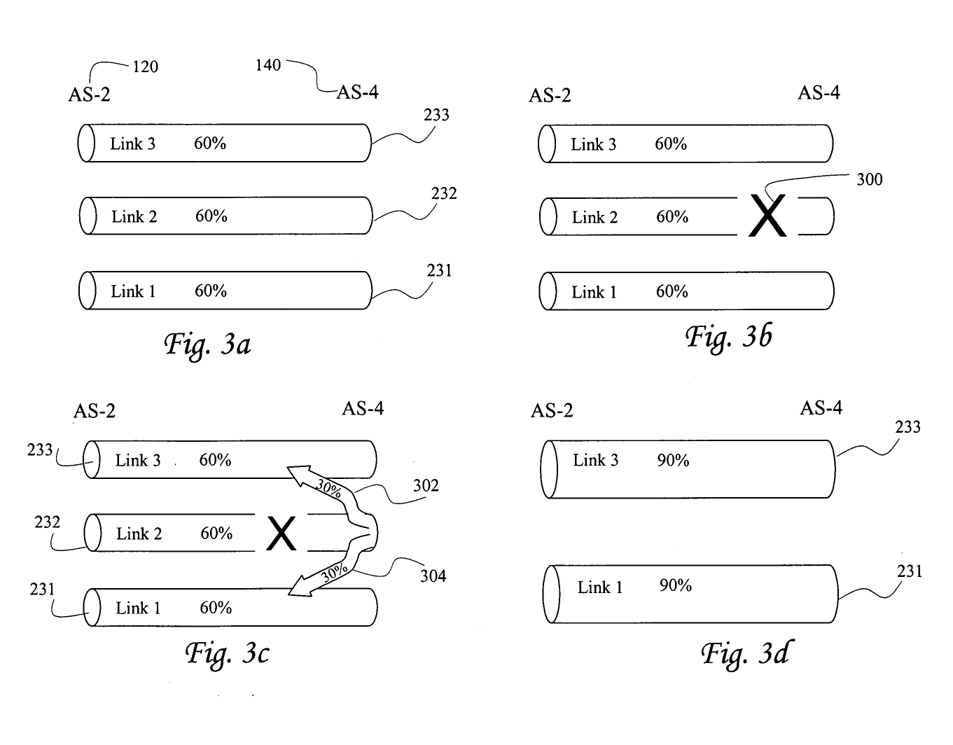

It was previously identified in FIG. 2 that traffic AS-2 can select which link 231, 232, 233 is used when sending information from AS-2 to AS-4. However, it is desirable that AS-2 manages, or at least influence, the link that is used for incoming traffic (e.g., traffic sent by AS-4). Obviously, since AS-4 is sending traffic to AS-2, AS-4 controls the final control as to what link is selected for sending traffic to AS-2, but BGP allows the two autonomous systems to indicate their preferences. Thus, AS-2 can provide a suggestion or preference as to which links should be used for incoming traffic to AS-2. The preference is indicated for a certain IP address destination value or range of values, referred to as a network prefix. Thus, AS-2 can use the BGP protocol to tell AS-4 that IP addresses in a first range should use link 233 as a first preference, and link 232 as a second preference. AS-2 could also indicate that second group of IP addresses should use link 231 as their first preference, and link 232 as a second preference. When AS-4 has traffic to route to AS-2, AS-4 will examine the destination IP address, determine what range it is in, and use the preferred link identifier. If that primary link identifier is not operational, then the secondary preferred link will be used. Thus, the MED attribute is one way that BGP allows information to be exchanged between peers regarding the selection of paths from multiples alternatives and by controlling the redistribution of routing information. It should be noted that BGP also provides for other mechanisms for exchanging routing information and that router manufacturers also define procedures for determining how data is routed, which can have priority over the above scheme.

BGP can be thought of as defining the “best” route for traffic to take, and defines a method of communicating an alternative link if the “best” link is not available. Thus, there is a mutual interest in autonomous systems mutually honoring such request. However, these procedures do not alter routing of traffic based on congestion of a link or in a router. If the primary link is available (though congested), the traffic will be queued up and the secondary link will not be used.

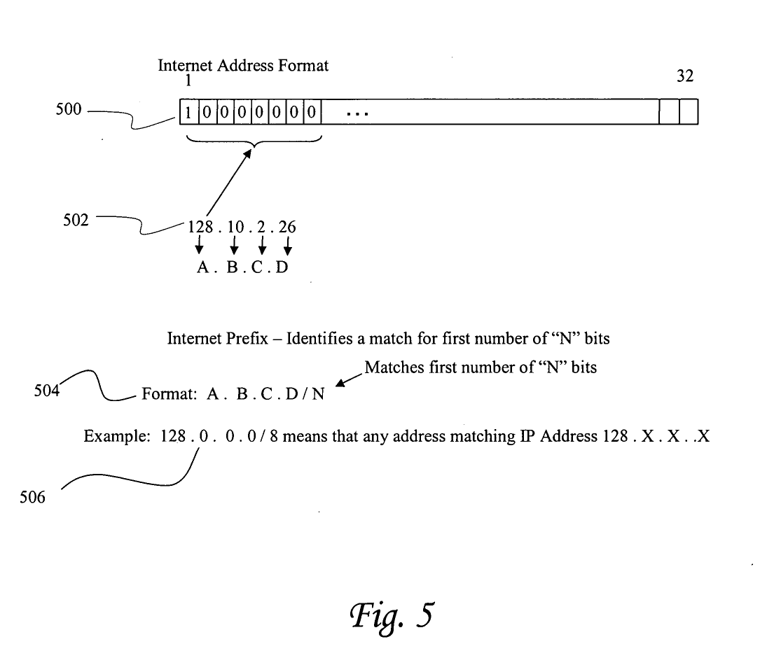

It was illustrated that selecting between a primary path and a secondary path was based on a range that the IP address was located in. These ranges can be described by using the concept of “Internet Prefixes.” An Internet Prefix is a contiguous group of Internet addresses wherein the grouping is designed to facilitate equipment processing by using a technique that ‘masks’ Internet addresses. This concept is illustrated in FIG. 5.

In FIG. 5, an Internet address (e.g., IP address) 500 is illustrated as a 32 bit number. These addresses are structured, i.e., they have various hierarchical structures that are standardized and well known. To facilitate representation to humans, they are often represented as a series of four numbers represented by eight bits and corresponding to a number between 0 and 255, wherein each number is separated by a period. This structure is well known by those skilled in the art of Internet protocols. One such address 502 is shown as 128.10.2.26. These “quad number” addresses can be represented generically as A.B.C.D. (Note—in this format the letters do not correspond to hexadecimal encoded numbers). An Internet prefix is denoted by A.B.C.D/N 504 where N represents the N number of the initial bits. The masking process means that only the first N bits are examined to see if they match the indicated value. For example, an Internet Prefix of 128.0.0.0/8 means all Internet address in which the first 8 bits matches the number 128. Thus, 128.55.6.34 would match, as would 128.X.X.X where X is any allowable number. Because only the first eight digits are examined to determine a match and the remaining bits are ‘masked’ from view (so to speak), the format can be written as 128/8 since the B, C, and D numbers are not of importance. If a smaller range is desired, then more digits can be examined. An example of a smaller range would be 172.16.1.0/24. This could also be written as 172.16.1/24. Finally, if all 32 digits are examined, then the range of IP addresses is one.

By defining various values of N, various levels of granularity can be defined, allowing flexibility in managing the traffic. Typically, an ISP does not allocate Internet Prefixes to represent certain usage characteristics, since the ISP has allocated addresses to users (or internally) as needed. When the addresses were almost allocated, then additional values were obtained. Thus, an Internet Prefix typically has addresses associated with various types of users with various types of traffic characteristics.

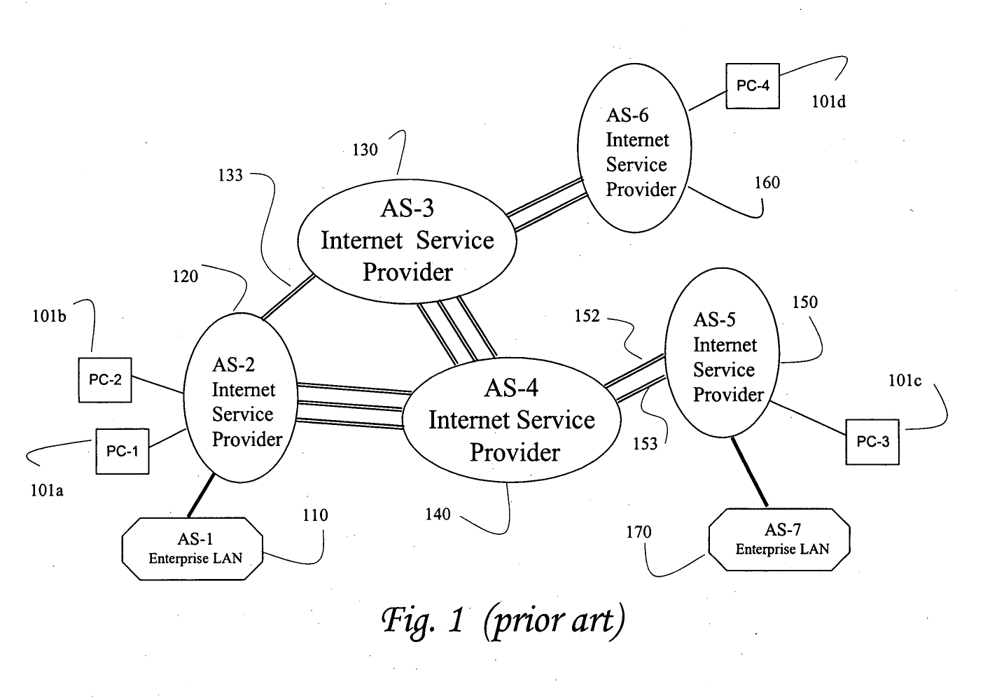

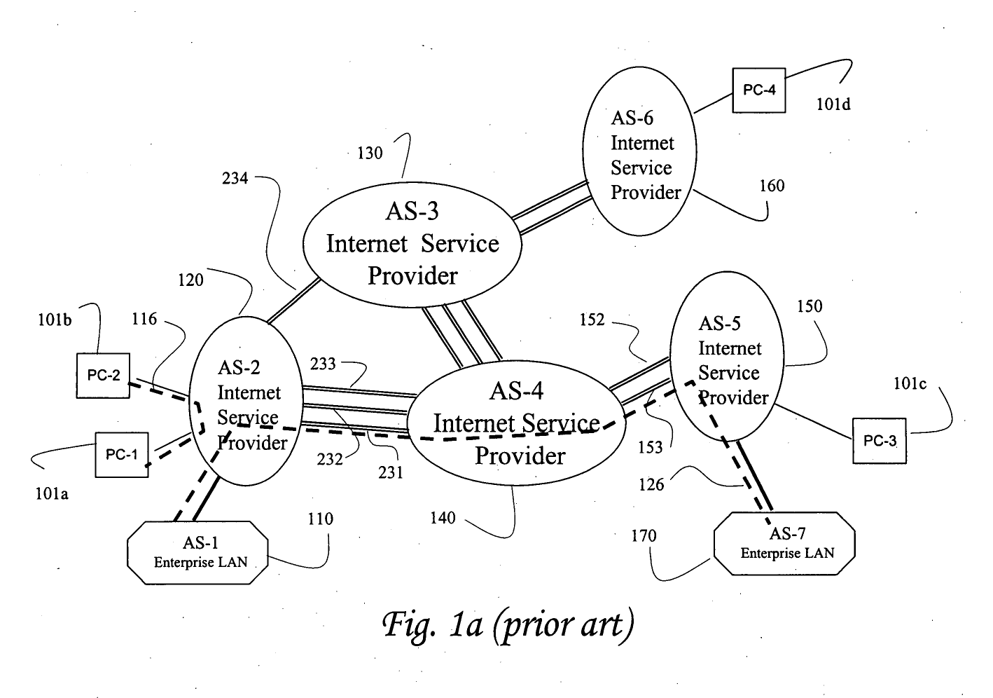

The IP Prefixes are used to define groups of traffic which can be potentially monitored and managed. For example, returning to FIG. 1a, the ISP AS-2 120 may inform AS-4 that certain Internet Prefixes being delivery by AS-4 to AS-2 that are destined for AS-1 be delivered over a certain link (illustrated in FIG. 1a as link 231). Thus, the ISP AS-4 can monitor the IP Prefixes of the destination IP address and place it on the appropriate link when it is destined for AS-1. In this way, AS-2 can manage which link is used for incoming traffic. Thus, BGP allows autonomous system to communicate a preferred link for which certain incoming traffic is to be used by another autonomous system. This however, does not solve the problem of ensuring that traffic is evenly distributed on the three links between AS-2 and AS-4.

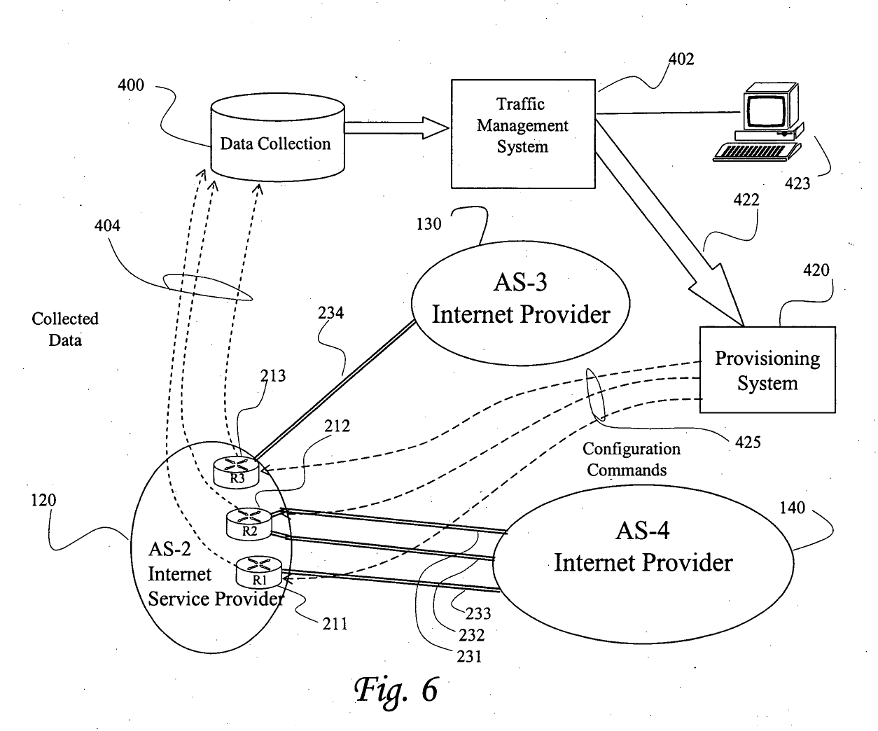

In order to evenly distribute traffic between two autonomous systems, the traffic must be first measured. Based on measurements and various computations, then the appropriate adjustments can be made. A high level view of one embodiment of the system components performing these functions are illustrated in FIG. 6. In FIG. 6, a portion of the various autonomous systems previously presented are shown, namely the AS-2 120 system with a communication link 234 that allows BGP protocol messages to be exchanged with AS-3 130. The link, in turn, is associated with a border router R4 213, which contains the BGP speaker. A corresponding BGP speaker peer exists in AS-3, but is not shown. Similarly, border routers R2 212 and R1 211, are associated with corresponding links 231, 232, 233 that convey BGP information to peers (not shown) in AS-4.

Each router contains capabilities, as is well known in the art, to collect various statistics and measurements regarding traffic it is handling. Each router R1-R3 is able to convey this data over links 404 to a data collection system or engine 400. Although each router is shown as having a link, these may be multiplexed on a single link on a single physical facility. The link can comprise a separate network of links and nodes designed for the purpose of managing the original network. The data stored in the data collection 400 system typically is obtained by periodically polling each of the routers, although this is not to preclude alternative embodiments, such as having each router autonomously periodically report traffic measurements to the data collection system. Thus, the data collection system typically maintains a history of the traffic data from the various border routers (e.g., BGP speakers) in a given autonomous system.

The routers typically collect and maintain traffic related data for each link. Although various means can be used, one common approach involves counting data transferred for each link. For example, R3 213 would typically maintain a counter of information that is transferred for a given link and increment it in real time as data is transferred. Typically, at a periodic time, the value of the count is recorded or read. Assuming the time period between counts is known, then the difference in the counter represents the amount of data divided by the time period provides the average data transfer. As long as this is performed prior to the counter “rolling over” or exceeding its maximum value, and accurate estimation can be obtained. This information is typically collected by a performance management or monitoring system deployed by each ISP or autonomous system, and collected into a database. Information is typically collected periodically, with a typical time period being around 5 minutes. The information may be stored directly into the data collection system 400 or further processed and then transferred to the data collection system 400.

The above information is typically collected and aggregated by performance management systems designed to gather and analyze data so as to facilitate network operation of an ISP. Typically, information is stored in tables, and indexed in various ways. In other embodiments, other applications may process the data so as to be presented to the Traffic Management System.

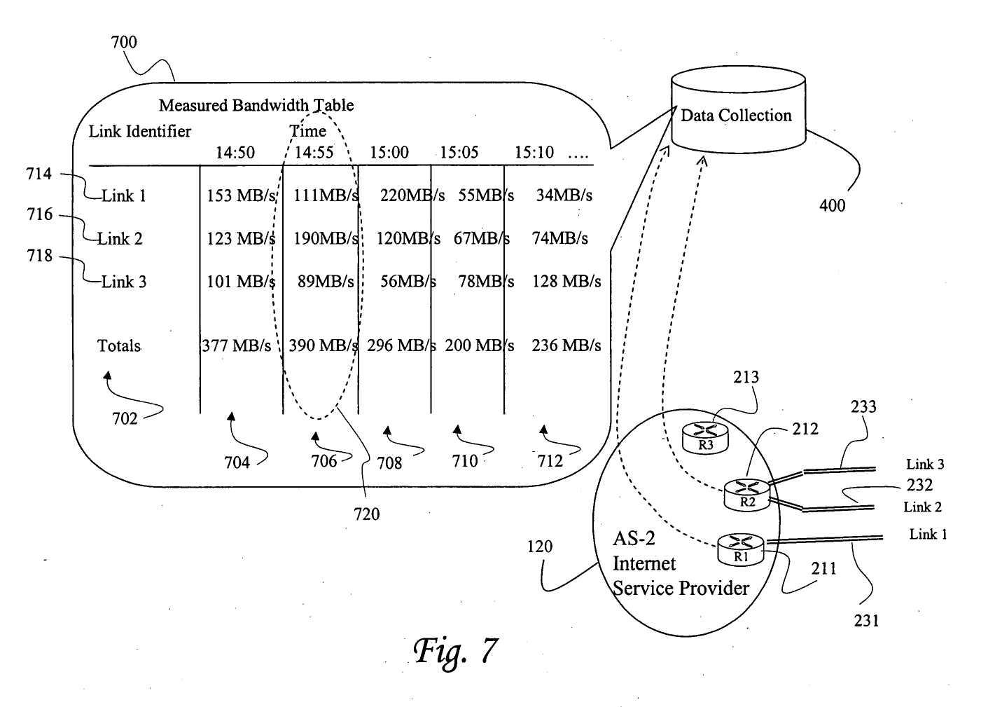

This data is analyzed by the Traffic Management System 402 (TMS) which aggregates all the traffic between two autonomous systems. For sake of example, assume that each of R1 and R2 record and report their bandwidth usage at the same time for the links between AS-2 and AS-4. In one embodiment, the data collected could be formatted in a table as shown in FIG. 7.

In FIG. 7, a measure bandwidth table 700 is maintained in the data collection system 400. The table lists all the links between the autonomous systems. In this case, for purposes of illustration, only a limited number of links are listed. Namely, the links between AS-2 and AS-4. These involve the link 1 231 from R1 213, and the link 2 232 and link 3 233 from R2 212. Thus, in the table, a column 702 is defined with rows of data for link 1 714, link 2 716, and link 3 718. The table maintains average link data over a five minute period. Thus, columns are defined 704-712 for data recorded at five minute intervals. These columns contain time recorded in a 24 hour format, thus the column labeled 14:50 704 would correspond to 2:50 p.m. The date information is not shown, but it is typically recorded as well. Thus, at five minute intervals, the average data transfer is indicated in megabits/second (or whatever metric is used). Although a very limited time period is shown in the table, the table contains data extending into the past for a longer, defined time and up to the present.

The data is aggregated producing an aggregate data transfer rate between AS-2 and its peer autonomous system for the relevant links. It is evident that the peak aggregate data transfer occurred at 14:55 when the average transfer rate was 111 MB/s incoming on link A1, 190 MB/s incoming on link B1, and, and 89 MB/s incoming on link C1 for a total of 390 MB/s 720. Since engineering of links is based on peak traffic volumes, the traffic between AS-2 and AS-4 should be engineered for a peak of 130 MB/s on each link (390 MB/s divided by 3 links) based on this historical data. Allocating 130 MB/s on each link would result in an even distribution of traffic.

Returning to FIG. 6, the previous data collection disclosed how the routers R1 211 and R2 212 collect measurement data on the links, report this data to the data collection store 400 and how the traffic management system 402 uses this data to determine a peak volume of data transfer between AS-2 and AS-4. However, the next question is how does the TMS 402 use this data to then manage the traffic on the link between AS-2 and AS-4?

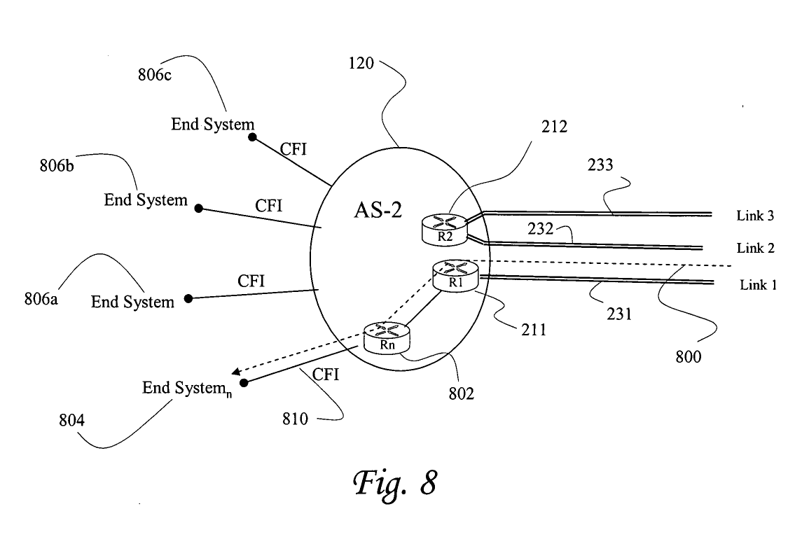

The answer begins by considering FIG. 8. Turning to FIG. 8, AS-2 120 is examined in detail with respect to incoming information over the border links 231, 232, 233 from AS-4 (not shown). Consider an arbitrary instance of traffic 800 that is sent to an IP destination address served by AS-2. It is received on one of the incoming links, in this case link 231, and router R1 211 examines the IP destination address and routes it internally in the AS-2 network to another router, Rn 802. The architecture of routers and their interconnection within AS-2 can be varied and range from simple to complex. However, at some point, traffic from an incoming gateway link reaches a router, represented here as Rn, which then sends the traffic over a “customer facing interface” (CFI). The CFI goes to the customer of AS-2, whether it is an individual end system, a private LAN, or corporate enterprise. What comprises the End System 804 is not relevant for purposes of the immediate discussion. It is evident that every message coming in via the gateway links works its way to an End System over a CFI. If it is not the End System 804 illustrated, then it must be one of the other end systems 806a-c.

Each router Rn serving an end system also maintains traffic measurements of data sent over the CFI. For the sake of simplicity, assume that each of the routers serving all the CFIs 810 records and reports measurements every five minutes back to the data collection system 400 of FIG. 6. Thus, the average data transfer on a five minute interval for all the routers serving each End Systems is stored in the Data Collection System.

Since the TMS previously identified the peak traffic time (recall this was exemplified as occurring at 14:55 or 2:55 p.m.), the TMS can then identify the average traffic for each end system during the peak time. In essence, each recipient of information, each End System's relative portion of the whole of the peak traffic is known. Since each End System is identified by an IP address or group of IP addresses, each traffic component of the whole is known.

However, there are typically a large number of individual IP addresses associated with an autonomous system and it is not necessary, nor desirable, to manage traffic between autonomous systems by managing each individual IP address traffic stream. First, each individual IP address represents traffic that is typically too small to manage, and there are too many individual IP addresses to efficiently manage. Rather, it is preferable to be able to manage traffic on an IP Prefix basis. Recall that IP Prefixes provide variable granularity to a network provider with respect to identifying groups of contiguous IP addresses. Thus, the TMS performs a logical mapping, in which the individual traffic volumes from IP addresses are grouped or associated with the appropriate IP Prefix.

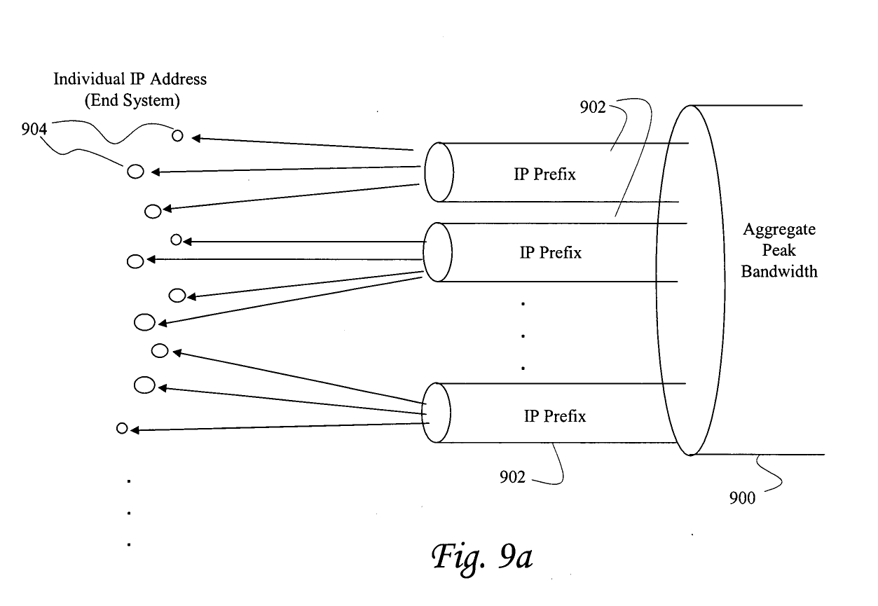

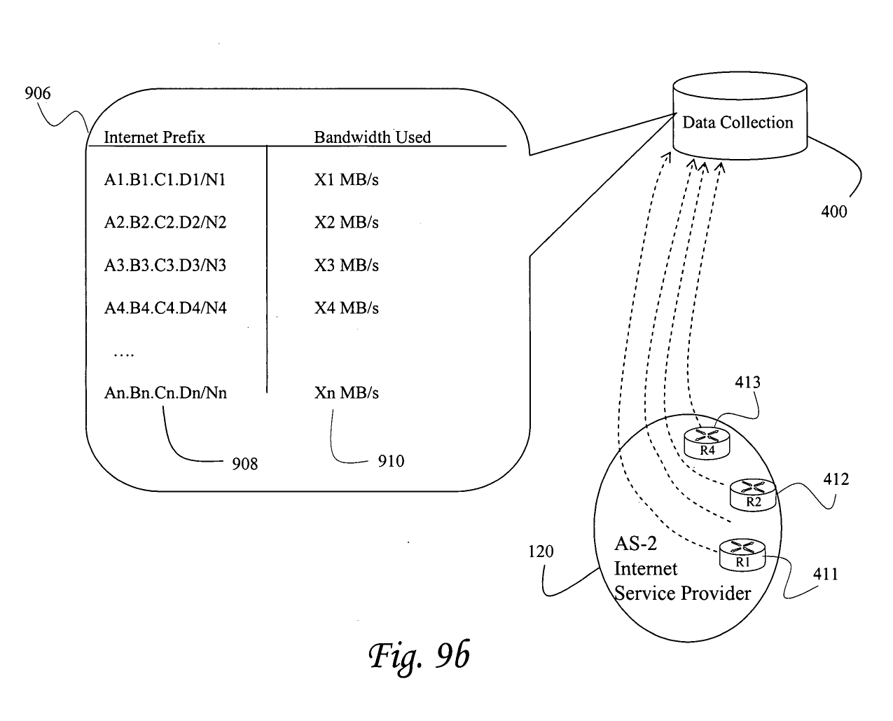

The mapping can be illustrated in FIG. 9a, as traffic coming from an autonomous system 900 destined for various IP addresses served by the autonomous system. Each individual IP address 904 is associated with traffic of varying bandwidth. Each individual IP address's bandwidth is associated with one of the plurality of Internet Prefixes 902. Recall that the Internet Prefix represents a contiguous grouping of IP addresses. Each Internet Prefix, in turn, is part of the traffic on the link 900. With respect to typical quantities, a large regional ISP may have less than half-a-dozen links to another autonomous system; up to several hundred Internet Prefixes defined, and millions of individual IP addresses of end systems.

After analyzing the collected date, the TMS creates a table, of which one embodiment is shown in FIG. 9b, representing the various Internet Prefixes used as the basis for managing traffic. In FIG. 9b, the table 906 contains a series of values of Internet Prefixes 908, which can be represented in various ways, but is illustrated in the table in the A.B.C.D/N format. The table may have several hundred values, and each prefix represents the aggregate CFI traffic associated with that prefix at the peak traffic time. Each Internet Prefix is associated with a traffic bandwidth value 910, shown here as a value X, with a bandwidth attribute. Although not shown, the data collection system typically also maintains an association of the Internet Prefix with the incoming link. Other attributes can be indicated in the table, but are not shown as the present information is sufficient to illustrate the principles of the invention.

The TMS then allocates the each of the Internet Prefixes to the appropriate resource (e.g., border links or gateway links). This allocation represents a variation of the classic “bin packing” problem that is well known in the area of computer science algorithms. The “bin packing” problem requires allocating a set of objects, each with a certain value, to a set of resources each with a capacity limit. Typically, the object are optimally “packed” into the resources without exceeding the limit of each resources. The definition of optimum may vary, but typically includes packing each bin to level equal to the other bins. These types of algorithms are defined as “NP” hard problems, in that the solutions are nondeterministic and cannot be solved in linear time. Fortunately, as will be seen, an effective scheme for managing traffic can be achieved without necessarily having to determine the most “optimal” solution of allocating Internet Prefixes to the border links. In the present case, the packing of the objects (aggregate bandwidth) into a resource (link with a defined bandwidth) may sometimes result in exceeding the available resource (bandwidth of the link). In other words, the TMS may allocate an Internet prefix to a link even though the peak capacity of the link will be exceeded. This scenario is discussed subsequently as a special case.

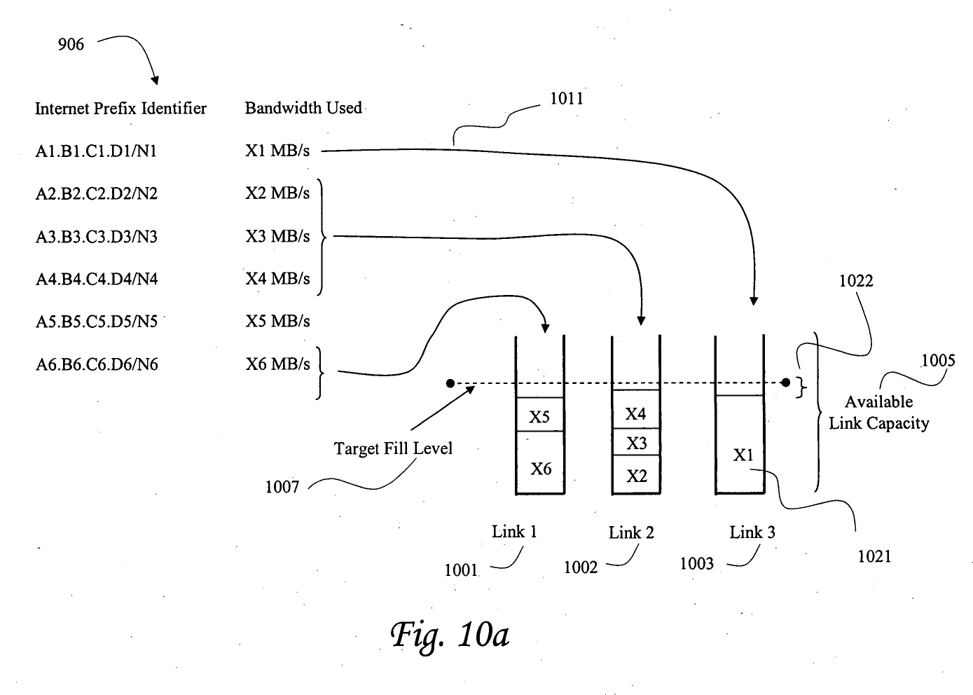

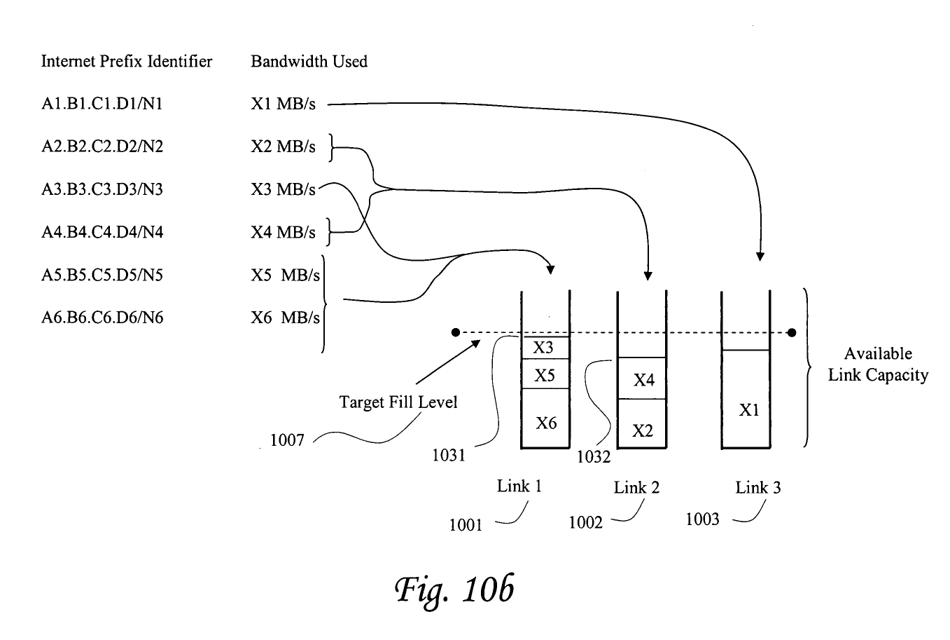

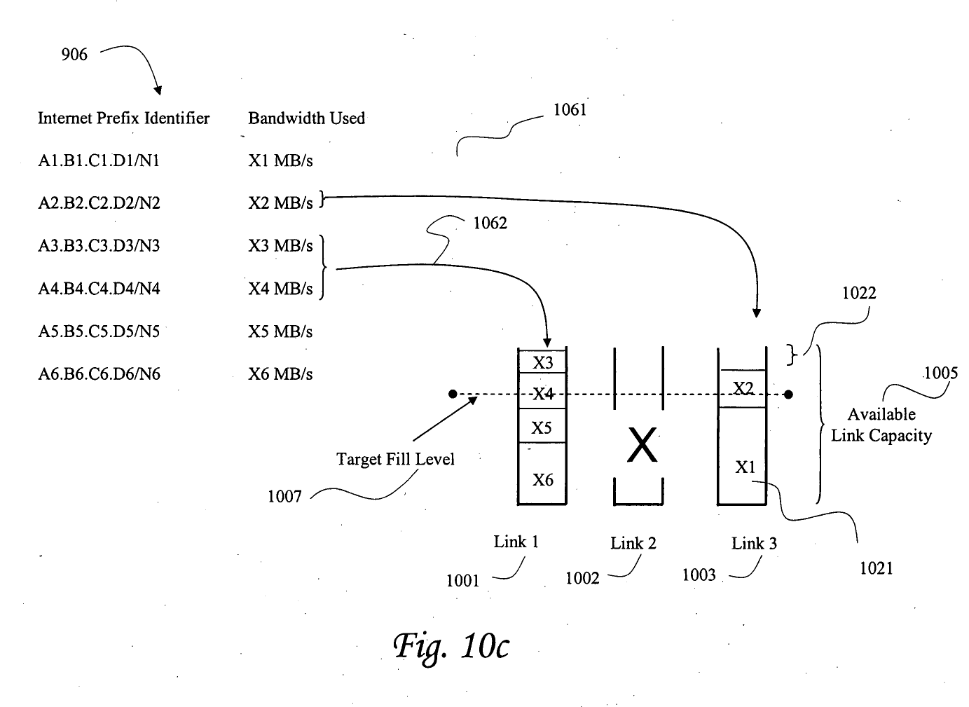

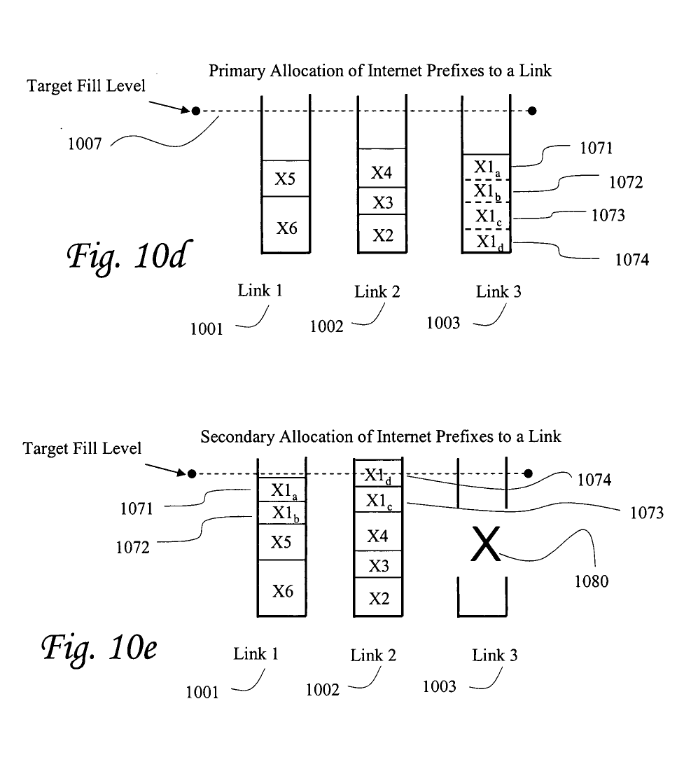

Turning to FIG. 10a illustrates the process for allocating or associating Internet Prefixes to a border link. The Internet Prefix table 906 is shown, but has been simplified so as to define only six Internet Prefixes to be allocated, labeled in the quad format. While many applications may have hundreds of values in a table, but the principles of the present invention can be demonstrated using just six values.

It is assumed that each of the Internet Prefixes has a bandwidth associated with it, which is typically different from the other values, and all these Internet Prefixes are associated with the border links between AS-2 and AS-4. Each Internet Prefix is associated with a bandwidth, labeled X1 through X6. The mapping process determined which Internet Prefix is then mapped to which one of three links. For illustrative purposes, each link, name link 1 1001, link 2 1002, and link 3 1003 are each shown as having the same available link capacity 1005. This can be thought of as a peak available bandwidth. In other embodiments, each link may have different link capacities. As previously discussed, it is desirable that each link be loaded so that the peak traffic does not exceed a certain level of the peak capacity. However, in other instance, this may not be avoidable. That certain level will vary based on the criteria set by the service provider. Assume in this illustration, that this level (e.g., target fill level) is set at approximately 60% and this is represented by the target fill level 1007 as a dotted line.

The TMS “solves” the bin packing problem by mapping each Internet Prefix to the appropriate link. In this illustration, the first table entry A1.B1.C1.D1/N1 is mapped 1011 to link 3 1003. Although the absolute value of X1 is not provided, it is illustrated as having a value such that X1 essentially “fills” up 1021 the available bandwidth of link 3. Thus the available bandwidth 1022 after X1 is allocated in link 3 is not sufficient to allow any other Internet Prefix to be allocated to link 3. Doing so would “overflow” the target fill level for link 3. Although in practice it is rare for a single Internet Prefix to essentially “fill up” a link, it is useful for illustration purposes.

Next, the process similarly allocates the remaining Internet Prefixes X2-X6. Because link 3 is almost at the target fill level, these remaining Internet Prefixes must be allocated to the other links, and the solution illustrated maps X2, X3, and X4 to link 2; and X5 and X6 to link 1.

This mapping results in each link carrying a peak capacity that is less than the target fill level 1007. Further, the mapping also maintains a loading of each link that is relatively similar to other links. Qualitatively examining the load for links 1-3 shows that there is no significant disparity between the values of:
Link 1=sum(X5, X6);
Link 2=sum(X2, X3, X4); and
Link 3=sum(X1).

Compare this allocation scheme with the value shown in FIG. 10b. In FIG. 10b, a different allocation has been performed, one in which X3 of Internet Prefix has been allocated to link 1 1001 rather than link 2 1002. In this case, the relative loading of each links is less balanced than in FIG. 10a. In the case of FIG. 10b the relative fill level of link 1 1031 to link 2's fill level 1032 is greater than it was in FIG. 10a. However, even in FIG. 10b, the criteria is still met in that the target fill level 1007 is not exceeded. It is desirable that should any link fail, the traffic on the failed link can be allocated to the remaining links without overflowing the remaining link capacity of a link.

While the embodiments of allocating Internet Prefixes to primary links as shown in FIGS. 10a and 10b represent different allocation results, both embodiments illustrate the mapping of Internet Prefixes to links in which the target fill level is not exceeded. Both achieve the goal of allocating traffic to links so as to evenly distribute traffic on the links, although one could be argued to be more ‘even’ than the other. In both schemes, the traffic may change over time, and should historical traffic data show that a link will reach capacity with its existing capacity or exceed its target fill level with the existing traffic, the entire analysis can be repeated resulting in the traffic being re-distributed, and possible avoiding the deployment of additional between the two autonomous systems.

Recall however, that Internet Prefixes are also associated with a secondary link. The secondary link is used when the network routers detect that a link is non-functional, for whatever reason. When a link is determined to be non-functional, then the traffic on that link is routed to the next best route, which is defined by the secondary routing (e.g., secondary link). This changeover occurs without the TMS mapping the Internet Prefixes to the links. Thus, when a TMS establishes the mapping of an Internet Prefix to a primary link as shown in FIGS. 10a and 10b, it also establishes the secondary link mapping.

Turning to FIG. 10c, it illustrates how the secondary mapping is used. In this case, it is assumed that the primary mapping is that as shown in FIG. 10a. Thus, Internet Prefixes A2.B2.C2.D2/N2, A3.B3.C3.D3/N3, and A4.B4.C4.D4./N4 and their respective bandwidths X2, X3, and X4 are mapped to link 2 as the primary route. The Internet Prefix A2.B2.C2.D2/N2 is secondarily mapped 1061 to link 3 1003 and Internet Prefixes A3.B3.C3.D3/N3 and A4.B4.C4.D4/N4 are secondarily mapped 1062 to link 1 1001. While all Internet Prefixes have a secondary mapping, only the Internet Prefixes primarily mapped to link 2 are discussed for purposes of illustration.

Assume, now, that in FIG. 10c link 2 fails. The routers will automatically use the secondary route to reroute the three Internet Prefixes as defined above. The result shown in FIG. 10c is that link 1 1001 is nearly filled at capacity with the additional bandwidth of X3 and X4. Similarly, link 3 is closer to capacity with bandwidth X2 added. In each case, the target fill level of link 1 and 3 now exceeded, but the total capacity of the links 1 and 3 allow the bandwidth to be accommodated, and none of the rerouted traffic is lost. Thus, the initial allocation of the TMS of the primary/secondary routes allows ensures that not only are the links roughly utilized equally, but that when one link fails, the remaining traffic is not lost.

Thus, the TMS must solve another bin-packing problem, and this problem involves allocating the bandwidth of Internet Prefixes associated with a primary link to the other links, so as to not exceed the total capacity of a given link. Obviously, if all of the traffic on link 2 were simply shifted to link 1, then link 1 would be over capacity. Thus, the traffic must be evenly distributed among the remaining links.

FIG. 10c also illustrates another potential application and benefit of the present invention. This involves the case in which it is not possible to allocate the bandwidth associated with a failed link so as to avoid congestion. Specifically, assume that the capacity of link 1 is not sufficient to accommodate the aggregate bandwidth of X3, X4, X5, and X6. This can occur simply because the links are not of sufficient capacity as well as if the links are of different capacity. Thus, when link 2 fails, and X3 and X4 are now routed using link 1, there is a possibility that data may now be lost or delayed on link 1 due to overflowing queues. Of course, an ISP cannot be certain that this will occur, but during the peak traffic time, this can be expected to occur. During such situations, the loss or delay of data on link 1 is not limited to certain Internet Prefixes on link 1. Specifically, data from any of the Internet Prefixes on link 1 may be lost or delayed. Consequently, in such a situation, it is expected that some data will be lost or delayed, and the next question is whether the Internet Service Provider can control which data is lost. By using the principles of the present invention, this can be controlled.

Assume that the TMS defined a secondary allocation of A4.B4.C4.D4./N4 to link 1, but does not allocate a secondary allocation for A3.B3.C3.D3/N3. Then, if link 2 fails, the traffic associated with A3.B3.C3.D3/N3 will not be rerouted on secondary path. This could be illustrated by FIG. 10c by removing the bandwidth X3 from link 1. Now, link 1's available link capacity does allow X6, X5, and X4 to be accommodated without traffic loss. In such circumstances, a network operator may assign criteria by which to prioritize certain Internet Prefixes so that preferred traffic is guaranteed to not be degraded, whereas lower priority traffic may be adversely affected. Such a priority scheme can be based on the algorithm disclosed in the aforementioned incorporated patent applications, namely U.S. patent application Ser. No. 09/970,386, filed on Oct, 2, 2001. Thus, in addition to evenly distributing traffic on gateway links, ensuring that traffic is appropriately handled during a failure of a link, the present invention also allows a an operator to prioritize traffic if there are not enough resources available during a link failure to handle all of the remaining traffic.

Another example of how to handle a potential link failure is shown in FIG. 10d. FIG. 10d is based on FIG. 10a, but with a slight modification in that the target fill level 1007 in FIG. 10d has been raised slightly for purposes of illustration. In FIG. 10d, the traffic associated with Internet prefix X1 consumes the majority of the capacity of link 3 1003. If X1 were allocated on a secondary basis to another link, then that other link would overflow; e.g., the allocated traffic would exceed the capacity of the link. In FIG. 10d, the traffic associated with Internet prefix X1 has been further divided into X1ₐ 1071, X1_{b} 1072, X_{c} 1073, and X1_{d} 1074. This is accomplished by defining sub-Internet prefixes that comprise the Internet prefix X1. From a primary allocation perspective, X1ₐ-X1_{d} are all associated with link 3.

FIG. 10e illustrates what happens when link 3 incurs a failure 1080. In this instance, two of the components of X1, namely X1ₐ 1071 and X1_{b} 1072 are allocated to Link 1 1001. The other two components of X1, namely X1_{c} 1073, and X1_{d} 1074 are allocated to Link 2. By doing so, at least a portion of the traffic of X1 can be allocated to a link (e.g., link 1) such that there is no “overflow” of the link capacity. Thus, there is no expectation that any traffic on link 1 will incur delays of congestions.

However, with respect to Link 2 1002, the allocation of the sub-portions of X1, namely X1_{c} 1073, and X1_{d} 1074 does result in exceeding the link capacity. Thus, it is expected that any of the traffic allocated to Link 2 may incur congestion or delay. In this scenario, at least a portion of the traffic associated with X1 is not effected by congestion, whereas allocating X1 as a whole on a secondary basis would result in all of the traffic associated with X1 (as well as any of the other traffic on the same link) encountering delay or congestion.

In FIG. 10e, link 2 1002 has traffic allocated to it that does exceed the link capacity (this also previously occurred in regards to FIG. 10c as well). In certain embodiments, this may not be avoidable. One such consequence is that traffic on the link may incur delay or congestion. However, another option is possible in which selective traffic on link 2 is terminated. Doing so would reduce the traffic, and if reduced so that the overall traffic is less than the link capacity, then none of the remaining traffic would encounter delay or congestion.

In this case, one option would be to terminate connections associated with an Internet prefix. However, doing so is likely to effect a broad range of traffic, since an Internet prefix can encompass a large amount of traffic. It is likely to include traffic which the ISP considers “valuable” as well as “low-value” traffic. In other words, the ISP may differentiate between infrequent, low-volume users transferring non-critical traffic and frequent, high-volume users transferring critical traffic. The ISP may differentiate these by providing low-priced services without service guarantees and higher prices services with service guarantees. However, these ends of the service spectrum (and variations in-between) are typically intermingled within a Internet prefix range. The Internet prefix range typically is not so granular so as to allow selection of traffic at this level. Thus, if the TMS is to selectively drop traffic, identification of the traffic using the Internet prefix may not be suitable.

One solution is based on the aforementioned customer facing interfaces (CFIs) from which data was collected. Recall that tables identifying the CFI with their traffic volume were made available to the TMS. These tables can also maintain a priority indication of the relative “worth” of the traffic. (For more information regarding this concept, see the aforementioned reference, “Behavioral Compiler For Prioritizing Network Traffic Based On Business Attributes”, U.S. patent application Ser. No. 09/970,396, publication no. 2002/0,123,901. The TMS can identify the CFIs associated with the overloaded link and selectively identify the CFIs which are low priority and to be effectively shut down. The TMS can provide information to the provisioning system identifying the CFIs, resulting in BGP protocol messages to be generated to other AS systems effectively precluding traffic destined for those CFIs. In this manner, the allocated traffic to an overloaded link can be reduced, so that the remaining traffic on that link does not encounter delay or congestion.

Another solution could be based on the TMS indicating to internal systems of the AS that connections associated with the identified CFIs should be terminated, which also serves to reduce the traffic associated with the gateway links. In this solution, BGP messages may be used internally in the AS, but BGP attributes are not exchanged between peer border routers.

Although the present invention and the previous discussion accommodated primary and secondary routes, the principles disclosed can also apply to tertiary routes, quad routes, etc. Those skilled in the art of networking will appreciate that the present invention can be used to accommodate for multiple simultaneous link failures. However, because it is standard in the ISP industry to plan for outages of a single link, and not to plan for outages involving simultaneous multiples links, the illustrations have focused on a single link failure. Thus, there typically is only a need to define a primary and secondary route as illustrated.

Further, as illustrated from FIG. 10a and FIG. 10b, there are various solutions to the “bin packing” problem of allocating Internet Prefixes to a set of resources, e.g., link bandwidth capacity. While it is desirable that the difference between the target fill level and the actually allocated bandwidth be similar for the different links (e.g., “evenly” distributing the traffic), as long as the target fill level is not exceeded, then the allocation can be considered acceptable. Similarly, when a link fails and the traffic of the reallocated Internet Prefixes does not exceed the link capacity on the remaining links that too, could be considered acceptable. While it may be desired that the remaining links exhibit balanced link capacity, that is not necessarily required. Thus, a variety of algorithms can be used to allocate Internet Prefixes to links, and what is considered “optimal” may vary based on business considerations. For example, one algorithm may find a solution for allocating traffic among links faster, whereas another algorithm may allocate the traffic in a more even distribution. As long as the target fill level is not exceeded, then either may be considered “optimal.” In other embodiments, it may not be possible to avoid exceeding the fill level, and the “optimal” distribution may be minimizing the number of links which have their capacity exceeded, minimizing the total traffic that may be impacted, etc. In short, a AS provider may define various criteria to influence the allocation of traffic. For example, certain Internet prefixes could be considered as more important than others, and therefore allocated to a link in which the overall capacity is not exceeded, whereas other Internet prefixes not as important are allocated to a link where the capacity is exceeded.

Returning to FIG. 6, the process of gathering the necessary data from the AS-2 120 ISP has been disclosed, along with the tabulation of the data (either by the data collection store 400 or the TMS 402), and along with the processing by the TMS of the Internet Prefix data to allocate the traffic against a set of links 231-233. As discussed, the determination of which Internet Prefixes are allocated against which links is for the purposes of defining a primary and secondary route for that traffic. Once the TMS 402 has determined the proper allocation, then this allocated must be announced to the various routers 211-213. There are various embodiments in which this can occur.

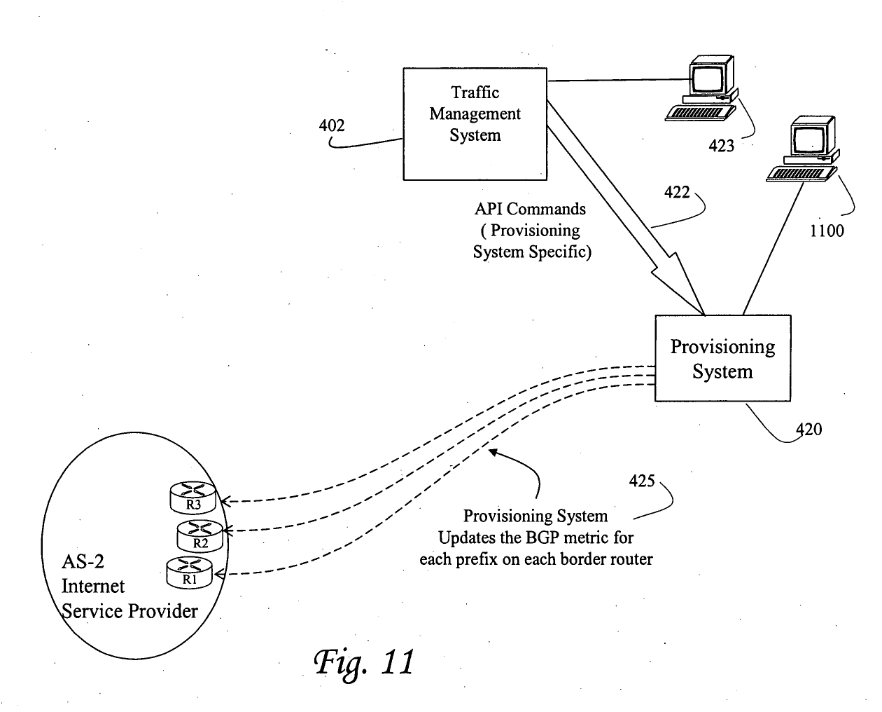

In one embodiment, the solution could be reported to a network manager via a terminal 423 as shown in FIG. 11. The network manager then uses that data to configure the appropriate routers using the existing configuration procedures defined by that network. Typically, this may involve by using another terminal 1100 that communicates with the provisioning system 420. Alternatively, the same terminal 423 could use a LAN to communicate with the provisioning system 420.

While there may be hundreds of Internet Prefixes, the number of connections between autonomous systems is limited, and this is a procedure that could be done manually, perhaps in a few hours time. Since it is expected that this process would occur periodically (e.g., weekly or monthly), this embodiment is feasible. It is not necessarily required that the collection of data, analysis, and configuration of routers occur in real-time.

Another embodiment, as shown in FIG. 11, is for the TMS 402 to interface 422 with the network provider's provisioning system 420, which in turn sends the network equipment vendor specific commands 425 to the appropriate border routers. In the case of FIG. 11, a single provisioning/configuration system 420 is disclosed as being able to communicate with the various routers 211-213. In practice, the system 420 may comprise various provisioning systems to accommodate various vendor's equipment and protocols. The protocol between the routers and the provisioning system is typically defined by the router vendor. This protocol is not the BGP protocol, but messages are defined that are used to configure BGP parameters and/or affecting the exchange of BGP messages between the border speakers.

Further, the messages 422 used by the TMS to communicate with the provisioning system are also typically defined by the provisioning system manufacturer. The messages 422 sent by the TMS to the provisioning system, in turn, are typically mapped in some manner to messages 425 from the provisioning system to the routers, but since this is vendor specific, there are many embodiments.

The purpose of the messages from the TMS system to the router (ultimately) is to set certain BGP related parameters, which are called “attributes.” Recall that one BGP attribute was the Multi-Exit Discriminator (MED) (a.k.a. “metric”) used to indicate a preference for receiving information from a BGP peer. By setting this parameter, the primary and second route of incoming messages can be defined.

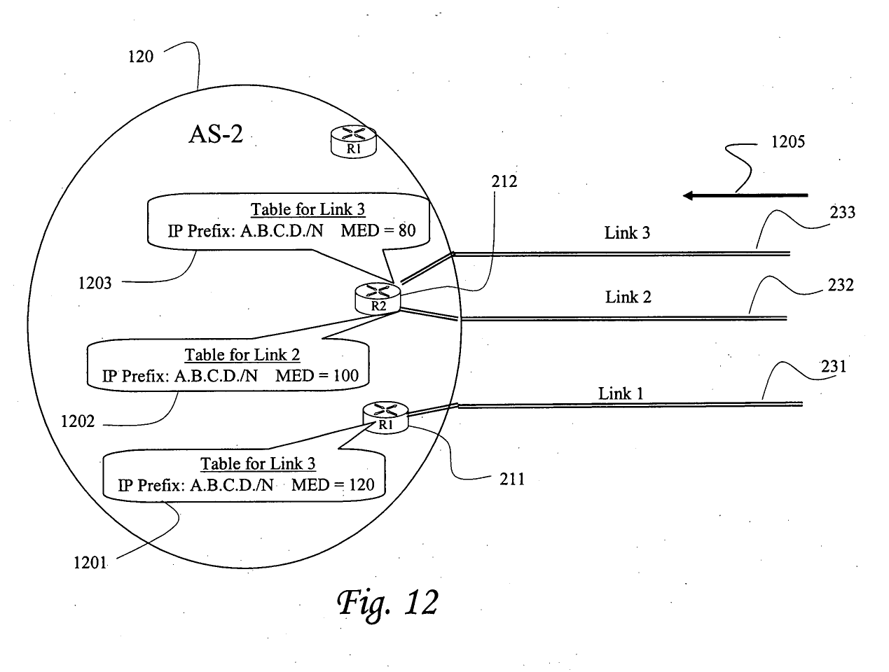

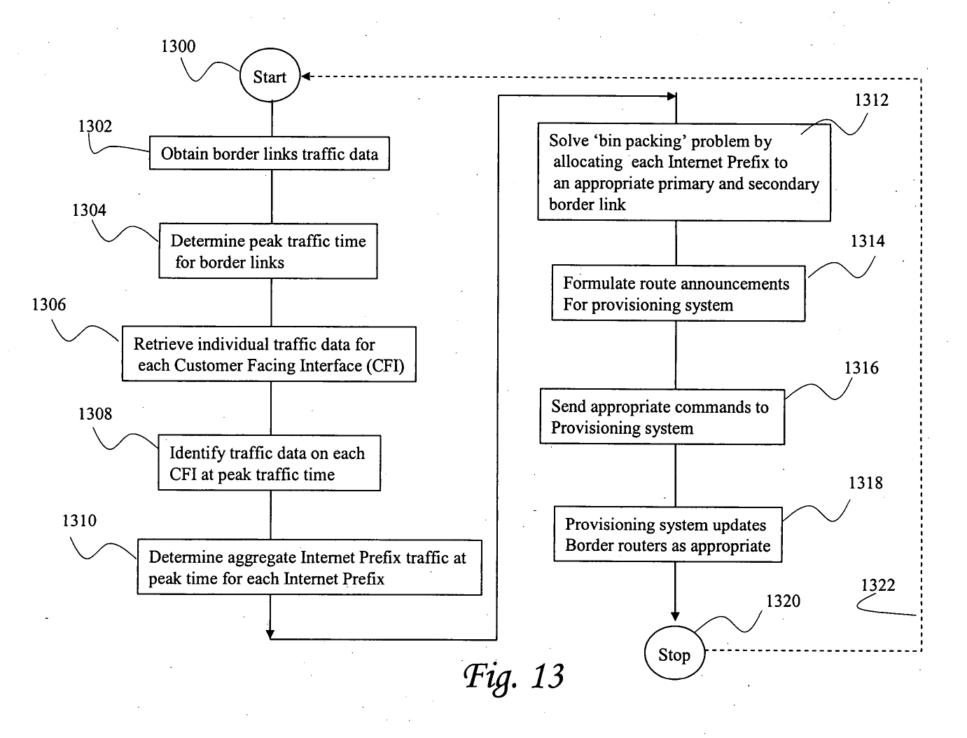

This application of the MED is illustrated in FIG. 12. In FIG. 12, the two routers R1 211 and R2 212 terminate links 1-3 231-233. These are the direct links between AS-2 120 and AS-4 (not shown). Each router maintains a list of BGP attributes associated with each link. Although many attributes are defined, the present discussion focuses on the MED attribute for purposes of illustration. Each table maintains an association between an Internet Prefix, A.B.C.D/N and a MED value. Of course, there are typically many Internet Prefixes defined in each table, but only a single Internet Prefix is disclosed for illustration purposes. The table 1201 for R1 211 shows that the Internet Prefix is set at 120. The corresponding table 1202 for link 2 shows that the MED value is set to 100. Finally, the corresponding table 1203 for link 3 shows that the MED value is 80.

The MED value is used by AS-2 to indicate a preference for incoming traffic to that Internet Prefix. Specifically, the MED value pertains to traffic 1025 coming into AS-2. The knowledge of a particular MED value for either router R1 or R2 is not going to affect that traffic since the MED values are used by AS-4. However, once the routers R1 and R2 communicate the MED value to their corresponding BGP peer in AS-4, then AS-4 will know how to route the traffic into AS-2.

The lower the MED value, the greater the preference for receiving traffic on that link. Thus, when AS-2 advertises a MED value associated of 80 associated with Link 3, it is indicating that for traffic associated with Internet Prefix A.B.C.D/N2, that AS-4 should route that traffic to AS-2 over link 3. A secondary preferred route is link 2, which has a MED value of 100, and the least preferred route is link 1, which has a MED value of 120. Although other MED values could be used, (e.g., 1, 2, and 3), it is industry convention to use 80 for a primary route indication, 100 for a secondary route indication, and 120 for others.

Thus, traffic coming into AS-2 with the designated Internet Prefix A.B.C.D/N is routed internally by AS-4 so as to be delivered over link 3 to AS-2 under normal conditions. If link 3 fails, AS-4 knows that the secondary route for that traffic is over link 2. Again, providers normally only plan for a primary and secondary route for traffic. Once AS-2 communicates its preferences for the Internet Prefixes, the routing tables in AS-4 are established and will automatically invoke the alternate routing when a link fails. In this manner, AS-2 can allocate a particular Internet Prefix to a link so as to evenly distribute incoming traffic, define secondary routes so that if a link fails, the other autonomous system will route the affected traffic in a predefined manner so as to avoid dropping any data.

The messages generated by the TMS to announce the update routes are dependent on the provisioning system interface, and are mapped by the provisioning system to messages to specific routers on a vendor dependent protocol. In theory, the TMS could provision each router separately, but typically the provisioning system provides a more convenient interface. Further, an ISP typically has deployed a provisioning system so that a convenient single point of contact can be used to interfacing the TMS with the provisioning system. The interface with the provisioning system is typically based on an application programming interface (API) so that an application installed on the provisioning system can interact with the TMS so as to obtain the required information. A series of function calls are defined allowing data to be queried, indicated, and conveyed. Although an API is typically used, other types of interfaces and schemes could be used, including having personnel manually interacting with the provisioning system based on information produced by the TMS.

In order to ultimately provision the link, the TMS must identify the Internet prefix and associate it with the appropriate link and make this information available either to the provisioning system (or another system interacting with the TMS and provisioning system) that then maps this information to the appropriate provisioning commands. The provisioning system can then identify the appropriate border router, and set the parameters as appropriate. Typically, the interaction between the provisioning system and the border router uses vendor specific protocols to administer the operation of that border router. Once the border router has the information, then it uses the standardized BGP protocol to relay this information to its BGP peer. Typically, the BGP MED attribute is conveyed from one BGP router to its peer, although other attributes may be involved. The standardized protocol for BGP messages for advertising the MED attribute can be found in various readily available documents. In the case of communicating the MED attribute, the BGP “Update” message can be used to convey the MED attribute.

To recap the process, the flowchart in FIG. 13 is referenced. The process begins 1300 and obtains the aggregate border traffic data 1302 for all the links between the managed autonomous systems. That data is analyzed, typically to determine a peak traffic time 1304. That peak traffic volume is then typically the basis for engineering the network and once that time is determined, then the individual components making up that traffic is retrieved 1306 and the peak traffic is identified 1308. Now that the individual CFI volumes are determined for the peak time, the next step is to determine the aggregate traffic for each Internet Prefix by aggregating the individual CFI traffic into the appropriate Internet Prefix 1310. Once the individual Internet Prefix traffic is determined, the allocation of each Internet Prefix is solved using the “bin packing” algorithm. This, requires that each link's capacity is not exceeded by the allocated bandwidth and must allocate primary and secondary routes. If the process has occurred before, then typically, this step “rearranging” the various primary and second routes based on traffic changes occurring since the previous determination. The system formulates the allocation of Internet Prefixes 1314 and then the TMS sends the appropriate commands to the provisioning system 1316, or in other embodiments, makes the information regarding the bin-packing solution available to the provisioning system where an application running on the provisioning system maps this to the appropriate provisioning commands. The provisioning system then sends the appropriate router specific provisioning/configuration commands 1316 to each of the effected routers 1318. At this point, the process is complete 1320.

As mentioned, traffic volumes change over time. New subscribers are added, traffic characteristics change, volumes may increase, etc. Thus, performing this analysis once provides an accurate method of managing inter-autonomous system traffic, but only to the extent that the traffic does not change over time (which, of course, it does). Thus, FIG. 13 shows a looping process 1322 in which the entire process is repeated. How often this occurs depends on how quickly the traffic profiles change and how frequently the network operator desires to repeat the process. Typically, once a week should accommodate an ISP, whereas other networks may execute this monthly (e.g., every 30 days or so), or at some other periodic interval. However, it is expected that the process is periodically executed since it is expected that a network's traffic characteristics will change over time. By repeating the measurement, analysis, and configuration, providers can ensure that traffic is evenly distributed and that congestion during a link failure is minimized. Further, the expensive peering links are optimized, furthering the avoidance of purchasing unnecessary links for protection or unnecessarily increasing the bandwidth of existing links.

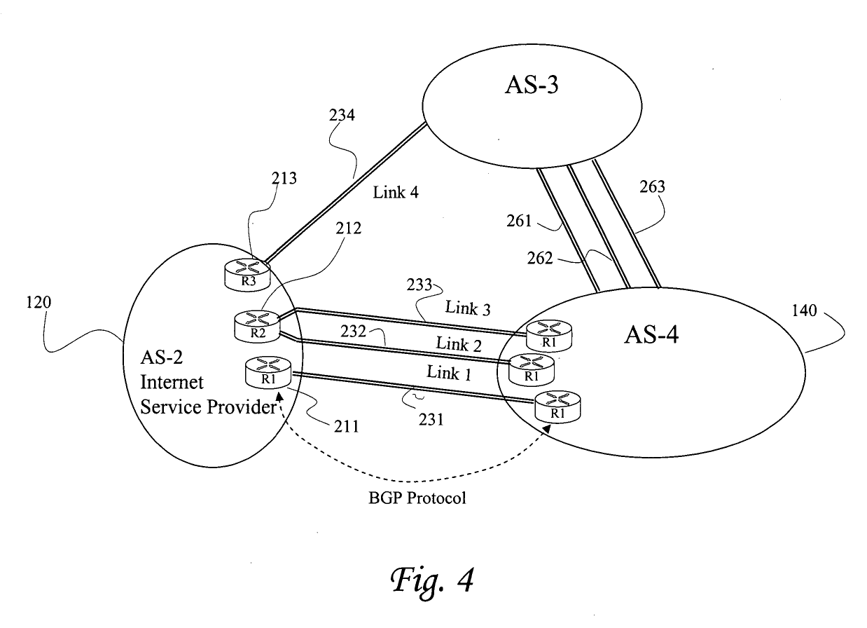

The procedures for configuring the BGP routers were illustrated only using the MED metric. This is typically the result when all the gateway links being managed at a given autonomous system interconnect with one other autonomous system. Specifically, this corresponds to when the gateway links being managed correspond to, for example, links 1-3 between AS-2 and AS-4 as shown in FIG. 4. However, in other scenarios, an AS may have gateway links to a plurality of other AS. Returning to FIG. 4, AS-2 120 has a link 234 to AS-3 and links 231-233 to AS-4 140. Thus, the TMS managing the links for AS-2 may be aware that some links are associated with AS-4 and others with AS-3. Further, it is possible that there may be cooperation between the AS-2, AS-3, and AS-4 as to how traffic should be handled between themselves. For example, AS-2 may indicate to AS-3 that incoming traffic on a given Internet prefix to AS-2 is to primarily be received on link 4 234. However, if there is a failure on link 4, the traffic should be sent from AS-3 to AS-4, and then from AS-4 to AS-2 over one of the links 1-3.

Further, it is possible that incoming traffic to AS-2 for a given may typically be received from AS-4, but also from AS-3 In other scenarios, the links other BGP attributes may be involved. For example, returning to FIG. 2, it is evident that traffic incoming to AS-2 120 from AS-4 140 may utilize any of the links directly connecting the two, namely link 1 231, link 2 232, or link 3 233. However, it is also possible that AS-4 could send information to AS-2 via AS-3. Thus, information coming into AS-2 on link 4 234 could be a secondary path from AS-4 for when there is a failure on links 1-3 231-233.

Indicating an alternate route involving other transit autonomous system can be indicated by a border router by using the BGP “Community” attribute that allows a method of grouping destinations with respect to routing decisions. Thus, the route announcements formulated by the TMS (and the provisioning system in turn), do not always involve the MED attribute exclusively, but may involve other BGP messages, including the “Community” messages. Further, as the BGP protocol evolves, it is possible the principles of the present invention could involve effecting of routes using future attributes or extensions.

Further, although the specification has disclosed the present invention in regard to a limited number of links and Internet Prefixes, in many embodiments, greater numbers of link and Internet Prefixes may be involved. The limited examples facilitate illustrating the principles without unduly a complicated presentation of the concepts. Further, as was discussed, the provisioning of the routers may utilize a variety of protocols and procedures, but each of these embodiments is intended to be within the scope of the present invention.

Those skilled in the art will readily appreciate that variations of the embodiments illustrated are possible. It should be emphasized that the above-described embodiments of the present invention are merely possible examples of various embodiments to set forth a clear understanding of the principles of the invention.

Any variations and modifications may be made to the above-described embodiments of the invention without departing substantially from the spirit of the principles of the invention. All such modifications and variations are intended to be included herein within the scope of the disclosure and present invention and protected by the following claims. Also, such variations and modifications are intended to be included herein within the scope of the present invention as set forth in the appended claims. Further, in the claims hereafter, the structures, materials, acts and equivalents of all means or step-plus function elements are intended to include any structure, materials or acts for performing their cited functions.

That which is claimed:

1. A method of managing traffic on a plurality of links between a first autonomous system and a second autonomous comprising the steps of:
receiving a plurality of traffic measurement data associated with a plurality of customer facing interfaces associated with the first autonomous system wherein the traffic measurement data is associated with the traffic time;
allocating each one of the plurality of the traffic measurement data to one of a plurality of Internet prefixes, wherein each Internet prefix is associated with the first autonomous network;
determining an aggregate traffic volume associated with each of the one of the plurality of Internet prefixes by summing each one of the traffic measurement data associated with the one of the plurality of Internet prefixes;
primarily mapping each Internet prefix to one of the plurality of links;
secondarily mapping each Internet prefix to another one of the plurality of links;
storing a table comprising the primarily mapping and secondarily mapping of each Internet prefix in a memory of a traffic management system; and
communicating the primarily mapping and secondarily mapping of each Internet prefix to a provisioning system using an interface of a traffic management system.

2. The method of claim 1 further comprising the steps of:
determining a traffic time associated with the plurality of links carrying traffic from the second autonomous system to the first autonomous system; and
identifying a set of customer facing interfaces associated with the first autonomous system.

3. The method of claim 2 wherein the traffic time is based on a peak traffic time.

4. The method of claim 1 further comprising the step of generating messages from the provisioning system to a plurality of border routers wherein each one of the plurality of border routers receives traffic from one of the plurality of links from the second autonomous system.

5. The method of claim 1 wherein the step of communicating the primarily mapping and secondarily mapping of each Internet prefix to an interface of a traffic management system results in sending provisioning commands to the provisioning system using an application programming interface.

6. The method of claim 1 further comprising the step of:
receiving a human readable indication of the primarily mapping and the secondarily mapping of each Internet prefix from an output port of the traffic management system; and
using the human readable indication to generate keyboard input to the provisioning system.

7. The method of claim 1 wherein the step of primarily mapping each Internet prefix to one of the plurality of links further comprises the steps of:
summing each aggregate traffic volume associated with each Internet prefix primarily mapped with the one of the plurality of links to produce an second aggregate link traffic volume; and
verifying that the second aggregate link traffic volume is less than a target traffic volume level associated with the one of the plurality of links.

8. The method of claim 7 wherein the step of secondarily mapping each Internet prefix to another one of the plurality of links further comprises the steps of:
summing each aggregate traffic volume associated with each Internet prefix secondarily mapped to one of the plurality of links to produce a third aggregate link traffic volume; and
verifying that the sum of the second aggregate link traffic volume and the third aggregate link traffic volume is less than a link traffic volume capacity associated with the one of the plurality of links.

9. The method of claim 1 wherein the messages generated from the provisioning system define a BGP attribute communicated from the first autonomous system to the second autonomous system.

10. The method of claim 9 wherein the BGP attribute communicated includes a multi-exit discriminator (MED) value associated with one of the Internet prefixes primarily mapped to one of the plurality of links.

11. The method of claim 1 wherein the primarily mapping of each Internet prefix to one of the plurality of links occurs using a bin-packing software algorithm.

12. The method of claim 1 wherein the determining the traffic time associated with the plurality of links occurs by retrieving a plurality of traffic data associated with the plurality of links, the plurality of traffic data correlated with a plurality of times, examining each of the plurality of traffic data to identify the largest traffic volume, and identifying the associated time.

13. A method for managing traffic between a first Internet Service Provider (ISP) and a second ISP comprising the steps of:
allocating a plurality of customer facing interface traffic measurement for each one of a plurality of customer facing interfaces (CFIs) to one of a plurality of Internet prefixes, wherein each one of the Internet prefixes is associated with the first ISP;
determining an aggregate Internet prefix traffic volume associated with each one of the plurality of Internet prefixes by summing the CFI traffic measurements associated with each one of the plurality of Internet prefixes;
associating each Internet prefix as a primary route with one of a plurality of gateway links between the first ISP and the second ISP;
associating each Internet prefix associated with the one of plurality of gateway links as a secondary route with another one of the plurality of gateway links between the first ISP and the second ISP; and
announcing at least one BGP protocol attribute to at least one router interfacing with at least one of the plurality of gateway links wherein the BGP protocol attribute reference at least one of the Internet prefixes.

14. The method of claim 13 further comprising the steps of:
identifying a plurality of CFIs associated with the first ISP; and
receiving a customer facing interface traffic measurement for each one of the plurality of CFIs wherein each one of the plurality of customer facing interface traffic measurement is associated with a given time period;

15. The method of claim 13 wherein the given time period identifying the CFI traffic measurement for each one of the plurality of CFIs includes a time at which the plurality of gateway links between the first ISP and the second ISP experiences a peak traffic volume.

16. The method of claim 15 wherein the peak traffic volume is associated with traffic of the plurality of gateway links from the second ISP to the first ISP.

17. The method of claim 13 wherein the plurality of Internet prefixes associated with the first ISP is retrieved from a traffic management system.

18. The method of claim 13 wherein a sum of each aggregate Internet prefix traffic volume associated with one of the plurality of gateway links does not exceed a target traffic volume associated with the one of the plurality of gateway links.

19. The method of claim 18 wherein the target volume associated with the one of the plurality of gateway links is less than a percentage of the maximum traffic capacity of the one of the plurality of gateway links wherein the percentage is based on the equation (n−1)/n and n is the number of gateway links.

20. The method of claim 13 wherein the BGP protocol attribute announced to a router is a multi-exit discriminator (MED) value.

21. The method of claim 13 wherein the MED value announced to the router is associated with one of the Internet prefixes associated as a primary route with the one of the plurality of gateway links interfacing with the router.

22. The method of claim 13 wherein a traffic management system announces the BGP protocol attributes to a provisioning system and the provisioning system sends messages in response to a plurality of routers wherein each one of the plurality of routers is associated with one of the plurality of gateway links between the first ISP and the second ISP.

23. The method of claim 13 wherein the given time period is greater than 3 minutes and less than or equal to 60 minutes.

24. The method of claim 23 wherein the given time period is encompasses a peak traffic time associated with an aggregate traffic volume on the plurality of gateway links.

25. The method of claim 13 wherein the step of allocating the CFI traffic measurement for each one of the plurality of CFIs to one of a plurality of Internet prefixes results in a plurality of CFI traffic measurements allocated to at least one of the plurality of Internet prefixes.

26. The method of claim 13 wherein the sum of each aggregate Internet prefix traffic volume associated with a one of the plurality of gateway links as a primary route added to the sum of each aggregate Internet prefix traffic volume associated with the one of the plurality of gateway links as a secondary route does not exceed a gateway link capacity associated with the one of the plurality of gateway links.

27. The method of claim 13 wherein the steps are repeated within 31 days.

28. A computer readable media containing software for managing traffic between a first ISP and a second ISP, the software instructing a processor to perform the steps of:
retrieving a plurality of customer facing interfaces (CFIs) traffic measurements from a memory wherein each of the CFI traffic measurements are associated with a time;
retrieving a plurality of Internet prefixes from the memory;
allocating each one of the plurality of CFI traffic measurements to one of a plurality of Internet prefixes thereby associating each one of the plurality of CFI traffic measurements to one of the Internet prefixes;
determining an aggregate Internet prefix traffic volume for each Internet prefix by summing each one of the plurality of CFI traffic measurements allocated to the one of the plurality of Internet prefixes and repeating for each Internet prefix;
mapping each one of the plurality of Internet prefixes on a primary basis to a first identifier associated with a first link conveying traffic from the second ISP to the first ISP;
mapping each one of the plurality of Internet prefixes on a secondary basis to a second identifier associated with a second link conveying traffic from the second ISP to the first ISP;
summing a plurality of aggregate Internet prefix traffic volumes mapped to the first link on a primary basis producing a first link primary allocated traffic volume;
verifying that first link primary allocated traffic volume does not exceed a target traffic volume associated with the first link;
summing a plurality of the aggregate Internet prefix traffic volumes mapped to the first link on a secondary basis producing a first link secondary allocated traffic volume;
verifying that the sum of the first link primary allocated traffic volume and the first link secondary allocated traffic volume does not exceed a traffic capacity associated with the first link;
storing the mapping of each one of the plurality of Internet prefixes on a primary basis to the first identifier and the mapping of each one of the plurality of Internet prefixes on a secondary basis to the first identifier in a memory as configuration data in a memory; and
generating a series of messages on an interface of a computer system indicating a plurality of BGP protocol attributes based on the configuration data.

29. A system for managing Internet traffic received by a first ISP from a second ISP over a plurality of links comprising:
a data collection store maintaining in a memory
a) a plurality of Internet prefix data associated with the first ISP,
b) a plurality of customer facing interface (CFI) traffic volume data associated with a traffic time,
c) a plurality of link identifiers associated with the plurality of links,
d) a plurality of link traffic capacity data, wherein each one of the plurality of link traffic capacity data is associated with one of the plurality of link identifiers,
e) a plurality of aggregate Internet prefix traffic volume data wherein each one of the plurality of aggregate Internet prefix traffic volume data represents the aggregate traffic associated with one of the Internet prefix data;
a processor operatively connected to the database for retrieving and storing data, the processor configured to
a) retrieve the plurality of CFI traffic volume data and associate each one of the plurality of CFI traffic volume data with one of the plurality of Internet prefix data and summing each of the CFI traffic volume data associated with a given one of the plurality of Internet prefix data thereby producing the aggregate Internet prefix traffic volume data,
b) associate each one of the plurality of Internet prefix data with one of the plurality of link identifiers on a primary basis,
c) associate each one of the plurality of Internet prefix data with another one of the plurality of link identifiers on a secondary basis,
d) sum each of the aggregate Internet prefix traffic volume data associated on a primary basis for the one of the plurality of link identifiers thereby producing a primary aggregate link traffic volume data,
e) verify that the primary aggregate link traffic volume data does not exceed a target fill level associated with the one of the plurality of link identifiers,
f) store the association of each one of the Internet prefix on a primary basis and each one of the Internet prefixes on a secondary basis in the data collection store; and
a provisioning system, operatively communicating with the processor, configured to receive a plurality of route announcements.

30. The system of claim 29 wherein the processor is further configured to:
a) sum each of the aggregate Internet prefix traffic volume data associated on a secondary basis for the one of the plurality of link identifiers thereby producing a secondary aggregate link traffic volume data; and
b) verify that the sum of the primary aggregate link traffic volume and the secondary aggregate link traffic volume does not exceed the one of the plurality of link traffic capacity data associated with the one of the plurality of links.

31. The system of claim 29 further comprising:
a plurality of border routers, operatively connected to the provisioning system and receiving messages from the provisioning system, wherein the messages set BGP attributes.

32. The system of claim 29 wherein each one of the plurality of border routers interface at least one of the plurality of links and transmits a BGP message.
